(19) United States
(12) Patent Application Publication
(10) Pub. No.: US 2022/0076021 A1
(43) Pub. Date: Mar. 10, 2022

(54) System and method for automatic visual inspection with deep learning

(71) Applicants: Rajesh Krishnaswamy Iyengar, Menlo Park, CA (US); Ritika Nigam, Menlo Park, CA (US)

(72) Inventors: Rajesh Krishnaswamy Iyengar, Menlo Park, CA (US); Ritika Nigam, Menlo Park, CA (US)

(21) Appl. No.: 17/015,168

(22) Filed: Sep. 9, 2020

(51) Int. Cl. G06K 9/00; G06K 9/32; G06N 3/08; G06T 7/00

(52) U.S. Cl. CPC G06K 9/00744; G06K 9/00718; G06T 7/001; G06N 3/08; G06K 9/3233

(57) ABSTRACT

The present invention provides a visual inspection system implemented by a product manufacturing site wherein the system comprising an input module, a processing module, and an output module. The input module is configured for receiving a video stream of at least one or more products on a conveyor belt. The processing module is enabled to extract at least plurality of frames horn the video stream of the at least one or more products, received by the input module, select at least one or more frames from the at least plurality of frames haying an image of a product, and extract area of interest, excluding a background region, from the at least one or more dames having the image of the product. The processing module is configured to generate a product boundary lines including annotating the product boundary lines, from the extracted area of interest using an annotation deep learning module and generate at least one or more data points of the product from the annotated product boundary lines utilizing a data point deep learning module. Further, the processing module is configured to generate at least one indication, upon comparison of the generated at least one or more data points of the product with at least predefined data points of a sample product by using a product inspection deep learning module. The output module is configured to display the at least one indication. In some embodiments, the processing module uses at least one deep learning module to extract area of interest.

### FIELD OF THE INVENTION

The present invention provides a visual inspection system to detect defects in manufactured products, and pertain particularly to a method and system for using video stream for automatic visual inspection with deep learning.

### BACKGROUND OF THE INVENTION

In the world of manufacturing there are different types of visual inspection. There are hardware cameras and normal 3D or 2D cameras, which require software assistance to support the visual inspection process. Often these software assisted cameras require a controlled environment or do not provide the accuracy and speed without taking up a lot of time or the final deployment due to manual annotation. Additionally, the cost of cameras at scale is expensive, and the need to change them far different processes complicates the manufacturing environment.

This method requires a significant investment of time for deployment to use and is, therefore, outside the reach of the majority of manufacturers.

The conveyor system in the manufacturing shop floors gets worn due to wear and tear, and the computer vision system based visual inspection then starts providing higher error rates, because of which the conveyor mats need to be replaced frequently.

Therefore a need exists for a novel visual inspection system which can be quickly deployed inside a manufacturing plant. Finally, there is a need for the system to be rapidly reconfigurable and interchangeable to adapt to different environments.

### SUMMARY OF THE INVENTION

The present invention provides a system and method for automatic visual inspection inside a manufacturing plant to inspect defects in different parts of one or more products is on a conveyor belt using machine learning modules.

The present invention provides a visual inspection system implemented by a product manufacturing site wherein the system comprising an input module, a processing module, and an output module. The input module is configured for receiving a video stream of at least one or more products on a conveyor belt. The processing module is enabled to extract at least plurality of frames from the video stream of the at least one or more products, received by the input module, select at least one or more frames from the at least plurality of frames having an image of a product, and extract area of interest, excluding a background region, from the at least one or more frames having the image of the product.

Further, the processing module is configured to generate a product boundary lines including annotating the product boundary lines, front the extracted area of interest and generate at least one or more data points of the product front the annotated product boundary lines wherein the data points can be at least one of the but not limited to a product shape, a product size, a product length, a product height, a product width, a product thickness, a product pattern, a product finish to detect defects in the product. Further, the processing module is configured to generate at least one indication, upon comparison of the generated at least one or more data points of the product with at least predefined data points of a sample product. The output module is configured to display the at least one indication.

In one exemplary embodiment, annotating the product boundary lines is performed by an annotation deep learning module. The annotation deep learning module has been trained on annotation training data, the annotation training data comprising one or images for one or more sample product parts and an annotation line for each product part.

In another exemplary embodiment, the at least one or more data points of the product are generated by utilizing a data point deep learning module wherein the data point deep learning module is based on the annotated product boundary lines and has been trained on one or more sample data points for one or more sample products and manually annotated product parts.

In one embodiment a method for inspecting defects in a product inside a manufacturing plant is provided. The method comprising receiving a video stream of at least one or more products on a conveyor belt, wherein the method executable by a hardware processor enabled to extract at least plurality of frames from the video stream of the at least one or more products, received by the input module, select at least one or more frames from the at least plurality of frames having an image of a product, extract area of interest, excluding a background region, from the at least one or more frames having the image of the product, generate a product boundary lines including annotating the product boundary lines, from the extracted area of interest, generate at least one or more data points of the product from the annotated product boundary lines and generate at least one indication, upon comparison of the generated at least one or more data points of the product with at least predefined data points of a sample product.

### BRIEF DESCRIPTION OF THE DRAWINGS

The foregoing and other objects, aspects and advantages are better understood from the following detailed description of a preferred embodiment of the invention with reference to the drawings, in which:

FIG. 1 illustrates a block diagram of a visual inspection system implemented inside the manufacturing plant of a product, according to an exemplary embodiment of the present invention.

FIG. 2 illustrates a perspective view of the camera capturing the video stream of one or more manufactured products moving on a conveyor belt inside a plant/shop.

FIG. 3 illustrates an example flow chart diagram of the automatic visual inspection system for determining defects of the product using deep learning, in accordance with a preferred embodiment of the present invention.

FIG. 4 illustrates a flow chart of a flame selection from the multiple frames, in accordance with an exemplary embodiment of the present invention.

FIG. 5 illustrates a perspective view of the frame processing to extract the area of interest and exclusion of the background region.

FIG. 6 illustrates a perspective view of the product having annotated boundary lines, in accordance with an exemplary embodiment of the present invention.

### DETAILED DESCRIPTION OF THE INVENTION

The present invention be more completely understood through the following detailed description which should be read in conjunction with the attached drawing in which similar reference numbers indicate similar structures. All references cited above and in the fallowing description are hereby expressly incorporated by reference.

Reference will now be made in detail to the exemplary embodiment(s) of the invention. References to “one embodiment,” “at least one embodiment” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property element, or limitation. Further, repeated use of the phrase “in an embodiment” does not necessarily refer to the same embodiment.

Aspects of the present invention are described below with reference to flowchart illustrations and/or block diagrams of methods, and system according to embodiments of the present invention. The flowchart and block diagrams in the Figures illustrate the architecture, functionality, and operation of possible implementations of systems, and methods according to various embodiments of the present invention.

The present invention provides a system and method for automatic visual inspection inside a shop to inspect defects in different parts of one or more products moving on a conveyor belt without any human intervention. Some embodiments use advanced computer vision with deep learning techniques to accurately determine defects in the products manufactured in the plant. The deep leaning modules have been trained on images collected for thousands of sample products.

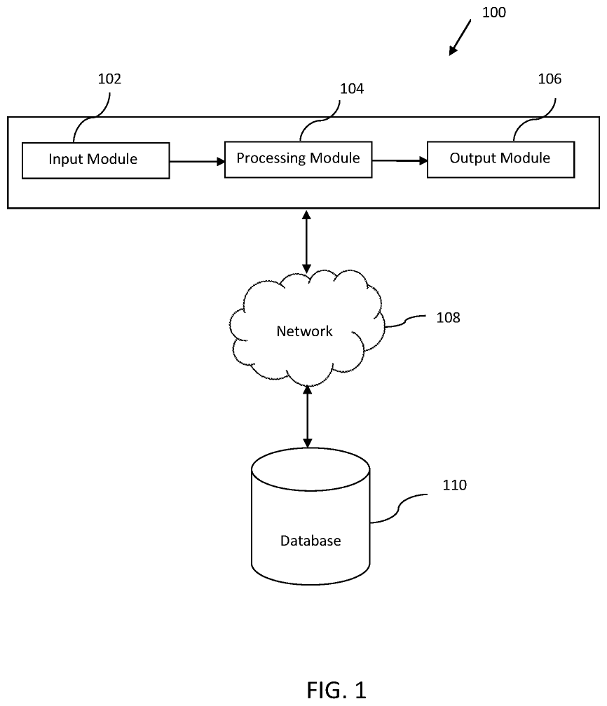

FIG. 1 illustrates a block diagram of a visual inspection system 100 implemented inside the manufacturing plant of a product, according to an exemplary embodiment of the present invention. The visual inspections system configured for performing automatic inspection of the manufactured product without human intervention. The system comprises an input module 102, a processing module 104, and an output module 106. The input module 102 can be any type of camera, including a 2D or 3D camera or any commodity camera, such as one in a mobile phone, DSLR, a fixed-lens rangefinder camera, drone camera, web camera or IP camera with a resolution of 720p/60fps or 1080p/30fps or any other etc. to acquire/capture a video stream of at least one or more products moving on the conveyor belt inside the plant. In one example, the input module 102 stores the video stream into a remote database 110 using a network 108. In one embodiment, the processing module 104 obtains the video stream from the database 110 using the network 108.

The network 108 may be wireless communication links, for example, shortwave, microwave, high frequency, wireless fidelity (Wi-Fi). Bluetooth technology, global system for mobile communications (GSM), code division multiple access (CDMA), second-generation (2G), third-generation (3G), fourth-generation (4G), 4G long term evolution (LTE), LTE Advanced, or any other wireless communication technology or standard to establish a wireless communication for exchanging data.

The processing module 104 is configured to receive the video stream from the input module 102 and convert the video stream into multiple frames and to analyze the one or more frames using deep-learning modules to detect and inform a user in real-time if any of the product contains any defects using at least one indication. The indication can be a positive indication (i.e., a product having no defects) or a negative indication (i.e., a product having one or more defect). The defect may be a void/pores, dents, scratches in manufactured parts of the product. In another embodiment's detection of oversized, undersized, missing parts/components and defect in dimensions, or geometric features (i.e., that are beyond a threshold range) can he measured in the manufactured products.

Further, the output module 106 is configured to display the at least one indication generated by the processing module 104 wherein the indication can be in form of a visual and/or audio indication.

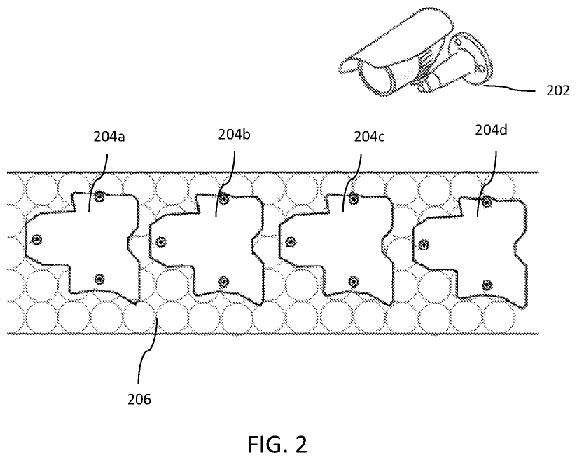

FIG. 2 illustrates a perspective view of camera 202 capturing the video stream of one or more manufactured products 204a, 204b, 204c, 204d moving on a conveyor belt 206 inside a plant/shop. In one example, at least one or more cameras are used to capture video streams of a plurality of products from different angles. In this manner, a set of the video stream of product parts (i.e., product sides) from different angles can be generated.

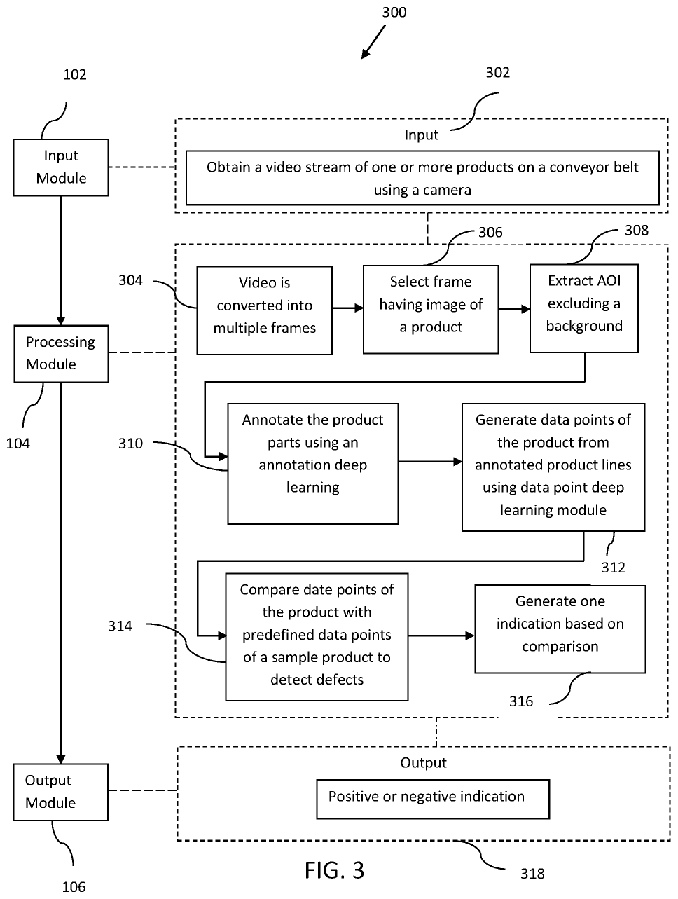

FIG. 3 illustrates an example flow chart diagram 300 of the automatic visual inspection system for determining detects of the product using deep learning, in accordance with a preferred embodiment of the present invention. Firstly, the input module 102 in step, 302 obtains the video stream of one or more manufactured products on the conveyor belt using a camera. Secondly, the processing module 104 is configured to, in step 304, convert the video stream into multiple flames. In one example, depending on the accuracy level expected for the visual inspection, the frame range can be between 300 frames to 30,000 frames. In step 306, select frames horn the multiple frames having an image of the product. In one embodiment, the frames are checked to ensure frames are of the high-quality image depicting the product parts needs to be annotated. The frame having a small discrepancy (i.e. not clearly showing or partial product image) is rejected. In one embodiment, an image recognition algorithm is used to detect the probability of the product in the frame. In step 308, extract AOI (area of interest) and the background region is excluded. The area of interest can be product image (i.e., localize an outer boundary of the product). In one example, the processing module is enabled to apply a bounding box around the product identified inside the frame. In one embodiment, a location coordinates of the product is identified. The background region can be an image of the conveyor belt (i.e., conveyor surface) on which product is placed. The conveyor surface with and without background mat, with keyboard, mouse and wires in the background and with a human hand in the background.

In step 310, annotate the product parts (i.e. product outer boundary, inner region, product side) by product boundary lines using an annotation deep learning module. In one embodiment, the annotation deep learning module that has been trained on annotation training data, the annotation training data comprising one or images for one or more sample product parts and an annotation line for each product part. Further, in step 312, generate one or more data points of the product from annotated product boundary lines using data point deep learning module wherein the data points may be at least one of the but not limited to a product shape, a product size, a product length, a product height, a product width, a product thickness, a product pattern, a product finish, a product depth to detect defects in the product. In another exemplary embodiment, the data point deep learning module based on the annotated product boundary lines and has been trained on one or more sample data points for one or more sample products and manually annotated product boundary lines. In one embodiment, the images of the products are manually annotated with pen/pencil, and the annotated images may be used as training data that may be fed to the data point deep learning module so that GPU can learn from annotation lines of different product parts.

Further, in step 314, the processing module compares one or more data points of the product with predefined data points of a sample product to detect defects in the manufactured product inside the plant. In step 316, one indication is generated based on the comparison in step 314. Lastly, the output module 106, in step 318, outputs the one indication wherein the indication can be a positive indication (i.e., no defect in the product) or a negative indication (i.e., one or more defects in the product).

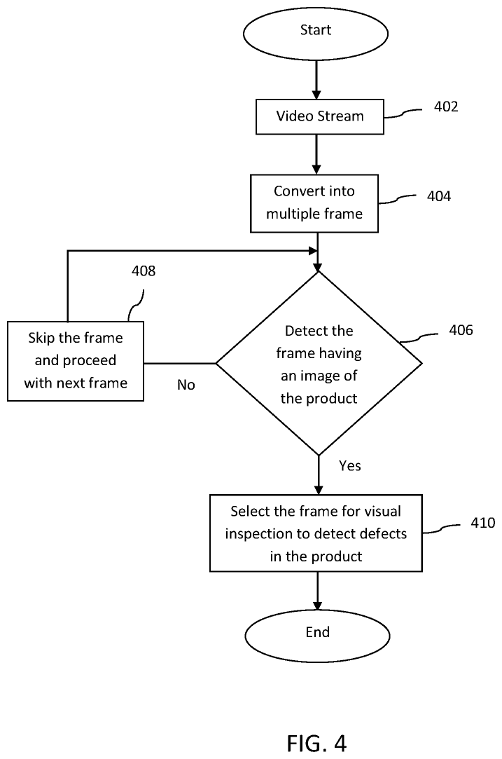

FIG. 4 illustrates a flow chart of a frame selection from the multiple frames, in accordance with aa exemplary embodiment of the present invention. At step 402, the video stream of the one or more products is collected. At step 404, the video stream is converted into multiple frames. At step 406, detect the frame having a full image of the product. If no (i.e., partial image of the product, the image of the product is absent or not clearly shown) at step 408, skip the frame and proceed with the next frame. If yes, at step 410, select the frame to proceed with visual inspection to detect defects in the product.

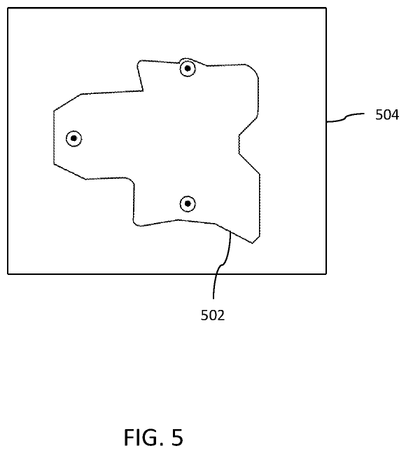

FIG. 5 illustrates a perspective view of the frame processing to extract the area of interest and exclusion of the background region. The product 502 (area of interest) is identified inside the frame 504 and the background region is removed by the processing module.

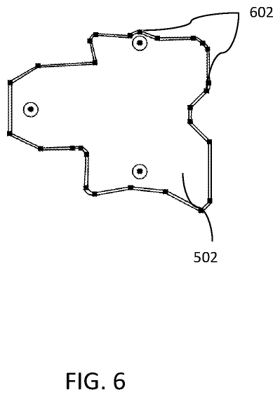

FIG. 6 illustrates a perspective view of the product 502 having annotated boundary lines, in accordance with an exemplary embodiment of the present invention. The processing module generates the product boundary lines 602 i.e., annotate each product part/feature for determining one or snore data points (i.e., a product shape, a product size, a product length, a product height, a product width, a product thickness, a product pattern, a product finish, a product depth) from the annotation lines using machine learning modules.

The present invention may be implemented using server-based hardware and software. The system includes at least one processor coupled to a memory inside the processing module. The processor may represent one or more processors (e.g., microprocessors), and the memory may represent random access memory (RAM) devices comprising a main storage of the hardware, as well as any supplemental levels of memory e.g., cache memories, non-volatile or back-up memories (e.g. programmable or flash memories), read-only memories, etc. In addition, the memory may be considered to include memory storage physically located elsewhere in the hardware, e.g. any cache memory in the processor, as well as any storage capacity used as a virtual memory, e.g., as stored on a mass storage device. The output module can be any display (e.g., LCD panel).

In one exemplary embodiment, a method for determining visually identified defect inside the manufacturing plant is provided. The method comprising receiving a video stream of at least one or more products on a conveyor belt, wherein the method executable by a hardware processor enabled to: extract at least plurality of frames from the video stream of thee at least one or more products, received by the input module, select at least one or more frames from the at least plurality of frames having an image of a product, extract area of interest, excluding a background region, from the at least one or more frames having the image of the product, generate a product boundary lines including annotating the product boundary lines, from the extracted area of interest, generate at least one or more data points of the product from the annotated product boundary lines and generate at least one indication, upon comparison of the generated at least one or more data points of the product with at least predefined data points of a sample product.

In one exemplary embodiment, the predefined data points of the sample product are stored inside the database. In another example, a difference between the comparison of the generated at least one or more data points of the product with at least one or more predefined data points of the sample product must below a predetermined threshold value to generate the positive indication (e.g., different between the manufactured product parts and sample product parts is between 1 micron and 5 micron) If the difference is above the predetermined threshold value the visual inspection system generates a negative indication (i.e., different between the manufactured product parts and sample product parts is greater than 5 microns).

In one embodiment, the visual inspection system uses a product inspection deep learning module for comparison of the generated at least one or more data points of the product with at least one or more predefined data points of the sample product. The product inspection deep learning module is trained to recognize acceptable and unacceptable (i.e., cracks, dings etc.) or defective product parts. The product inspection deep learning module can collect or receive a large set of training images depicting acceptable product parts/features.

In another exemplary embodiment, the area of interest is extracted from one frame having a product image using a machine learning module. The machine learning module can be trained with a set of training images including images depicting acceptable and unacceptable product/object parts or features.

In one example, the visual inspection system is used to identify visual defects on the product parts and provide the output related to the product as generated by the visual inspection system. The output, can be provided to the user via a user platform, mobile device, LCD, LED or any other device.

In one example, the visual inspection system is used to detect anomalies by looking at a few samples.

While the invention has been described in detail with specific reference to embodiments thereof, it is understood that variations and modifications thereof may be made without departing from the true spirit and scope of the invention.

1. A visual inspection system implemented by a product manufacturing site wherein the system comprising:
an input module configured for receiving a video stream of at least one or more products on a conveyor belt;
a processing module enabled to:
extract at least plurality of frames from the video stream of the at least one or more products, received by the input module;
select at least one or more frames from the at least plurality of frames having an image of a product;
extract area of interest, excluding a background region, from the at least one or more frames having the image of the product;
generate a product boundary lines including annotating the product boundary lines, from the extracted area of interest:
generate at least one or more data points of die product from the annotated product boundary lines;
generate at least one indication, upon comparison of the generated at least one or more data points of the product with at least predefined data points of a sample product; and
an output module configured to display the at least one indication.

2. The visual inspection system of claim 1, wherein generate at least one or more data points of the product from the annotated product boundary lines comprising:
determining a product shape, a product size, a product length, a product height, a product width, a product thickness, a product pattern, a product finish to detect defects in the product.

3. The visual inspection system of claim 1, wherein generate a product boundary lines including annotating the product boundary lines comprising: utilizing an annotation deep learning module that has been trained on annotation framing data, the annotation training data comprising one or images for one or more sample product parts and an annotation line for each product part.

4. The visual inspection system of claim 1, wherein generate at least one or more data points of the product, from the annotated product boundary lines comprising: utilizing a data point deep learning module based on the annotated product boundary lines, and has been trained on one or more sample data points for one or more sample products and manually annotated product parts.

5. The visual inspection system of claim 1, further comprising a remote database for storing the video stream of at least one or more products.

6. A method for inspecting defects in a product inside a manufacturing plant wherein the method comprising:
receiving a video stream of at least one or more products on a conveyor belt; wherein the method executable by a hardware processor enabled to:
extract at least plurality of frames from the video stream of the at least one or more products, received by the input module:
select a t least one or more frames from the at least plurality of frames having an image of a product: extract area of interest, excluding a background region, from the at least one or more frames having the image of the product:
generate a product boundary hues including annotating the product boundary lines, from the extracted area of interest;
generate at least one or more data points of the product from the annotated product boundary hires, and
generate at least one indication, upon comparison of the generated at least one or more data points of the product with at least predefined data points of a sample product.

7. The method of claim 6, wherein the at least one or more data points of the product can be at least one of a product shape, a product size, a product length, a product height, a product width, a product thickness, a product pattern.

8. The method of claim 6, wherein generate a product boundary lines including annotating the product boundary lines by utilizing an annotation deep learning module that has been trained on annotation training data, the annotation training data comprising one or images for one or more sample product parts and an annotation line for each product part.

9. The method of claim 6, wherein the at least one or more data points of the product from the annotated product boundary lines is generated using a data point deep learning module wherein the data point deep learning module has been trained on one or more sample data points for one or more sample products and manually annotated product parts.
